(19) United States
(12) Patent Application Publication
(10) Pub. No.: US 2020/0213485 A1
(43) Pub. Date: Jul. 2, 2020

(54) HOME SECURITY LIGHT FIXTURES

(71) Applicant: Russell Rossi, Boca Raton, FL (US)

(72) Inventor: Russell Rossi, Boca Raton, FL (US)

(21) Appl. No.: 16/797,453

(22) Filed: Feb. 21, 2020

Related U.S. Application Data
(63) Continuation-in-part of application No. 16/233,288, filed on Dec. 27, 2018.

(51) Int. Cl. H04N 5/225; F21V 33/00; H04N 5/232; F21V 21/26; F21V 23/00

(52) U.S. Cl. CPC H04N 5/2253; F21V 33/0056; F21V 23/003; H04N 5/23206; F21V 21/26; H04N 5/2256

(57) ABSTRACT

A home security light bulb adapter includes a light bulb base including a male bulb connector having male threads and a female bulb socket having female threads. The male bulb connector is electrically connected to the female bulb socket. A camera with night vision and a motion sensor are coupled to a housing. The housing is coupled to the light bulb base by an elongated rod. The camera, the motion sensor, a processor, and a wireless communications interface are electrically connected to the male bulb connector. When the male bulb connector is connected to a bulb fixture of a lantern light fixture, the camera is switched on when the motion sensor senses a motion. The processor then sends video signals to a remote device over a network via the wireless communications interface.

### CROSS-REFERENCE TO RELATED APPLICATION

This application claims is a continuation in part of U.S. non-provisional application Ser. No. 16/233,288, filed Dec. 27, 2018, the contents of which are herein incorporated by reference.

### BACKGROUND OF THE INVENTION

The present invention relates to a home security system with an easy-to-install screw bulb connector that screws into bulb sockets of pre-installed lighting fixtures.

Currently, to install security cameras and incorporate a light fixture with the camera, the user must replace the existing fixture. An entire replacement can be expensive and time consuming. Further, replacing the fixture yourself can be very dangerous and often times the consumer hires a professional for proper installation. Current spotlight fixtures and lanterns only include light emitters and fail to include any additional features.

As can be seen, there is a need for a home security light bulb adapter connectable to an existing light fixture using standard light bulb sockets and not having to hardwire a new fixture.

### SUMMARY OF THE INVENTION

In one aspect of the present invention, a home security light bulb adapter comprises: a light bulb base comprising a male bulb connector having male threads and a female bulb socket having female threads, wherein the female bulb socket is electrically connected to the male bulb connector; an elongated rod; a housing connected to the light bulb base by the elongated rod; a camera coupled to the housing and electrically connected to the male bulb connector; a motion sensor coupled to the housing and electrically connected to the male bulb connector; a wireless communications interface electrically connected to the male bulb connector; and a processor electrically connected to the male bulb connector; wherein when the male bulb connector is connected to a bulb fixture and the motion sensor senses a motion, the camera is activated and the processor sends video signals captured by the camera to the remote device via the wireless communications interface.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention;

FIG. 2 is an exploded view of an embodiment of the present invention;

FIG. 3 is a side view of an embodiment of the present invention;

FIG. 4 is a perspective view of an embodiment of the present invention;

FIG. 5 is a flow chart of an embodiment of the present invention;

FIG. 6 is a front perspective view of an embodiment of the present invention, shown in use;

FIG. 7 is a front perspective view of an embodiment of the present invention;

FIG. 8 is a bottom perspective view of an embodiment of the present invention;

FIG. 9 is a schematic view of an embodiment of the present invention; and

FIG. 10 is a front view of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

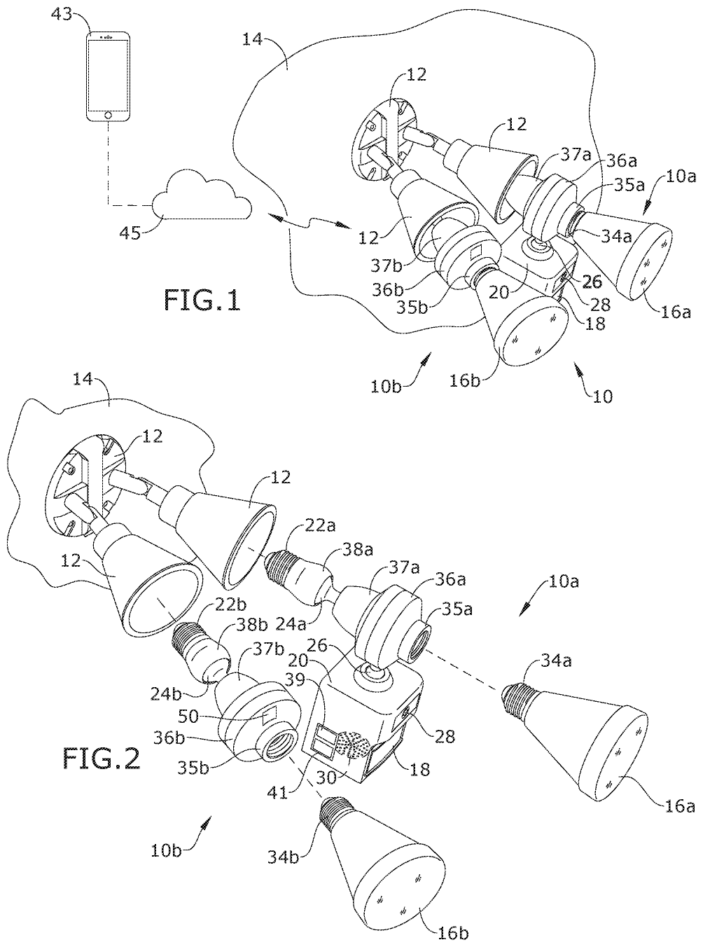

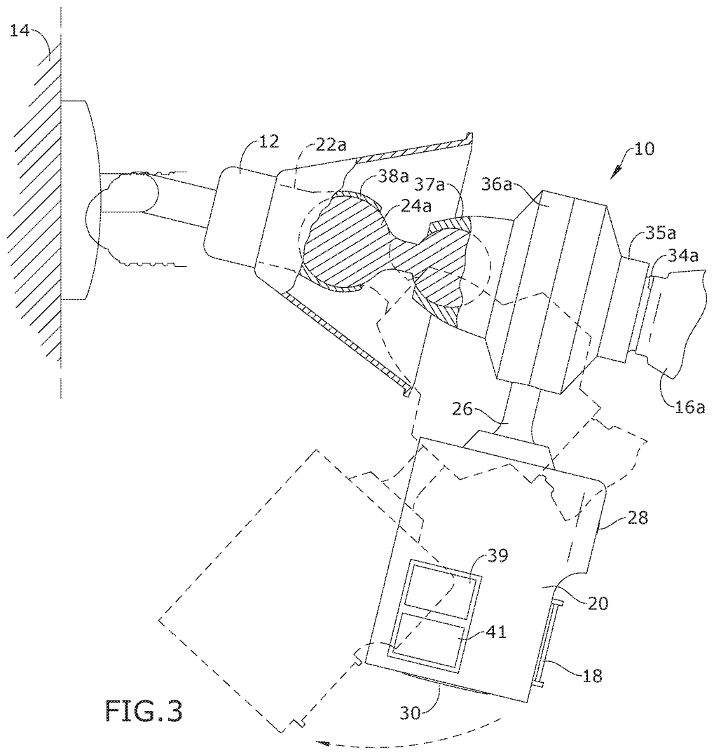

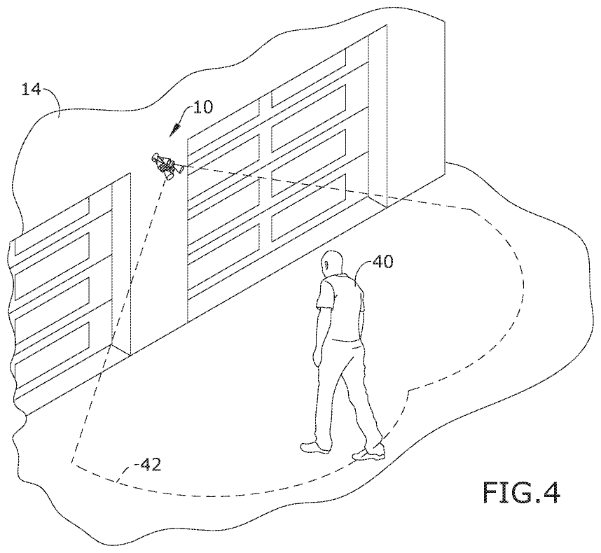

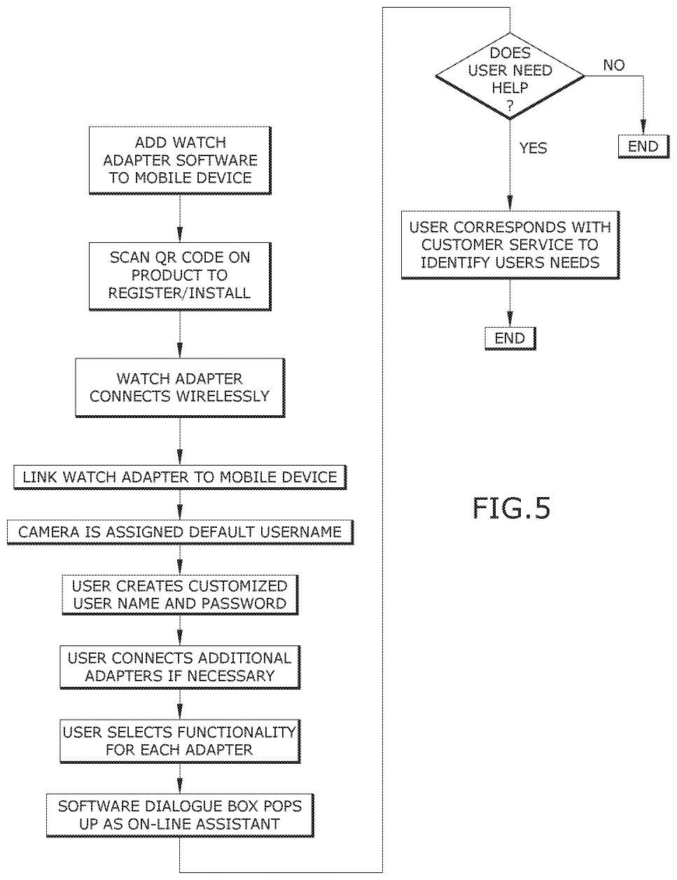

Referring to FIGS. 1 through 5, the present invention includes a home security light bulb adapter 10. The home security light bulb adapter 10 may include a primary adapter 10a and a secondary adapter 10b. The primary adapter 10a includes a bulb connector 22a having male threads. The primary adapter 10a further includes a bulb socket 35a having female threads. The bulb socket 35a is electrically connected to the bulb connector 22a. A camera 28 and sensors 18 are electrically connected to the bulb connector 22a. The camera 28 may have night vision capabilities. The adapter 10 further includes a wireless communications interface 39 and a processor 41 electrically connected to the bulb connector 22a. When the bulb connector 22a is connected to a bulb fixture 12 of a wall 14, the camera 28 and the bulb socket 35a are switched on when the sensors 18 sense a motion. The processor 41 then sends video signals to a remote device 43 over a network 45 via the wireless communications interface 39.

The remote device 43 of the present invention may be a laptop, desktop, or a smart device, such as a smart phone or a tablet with a computing system. The computing system is at least a processor and a memory. The computing system may execute on any suitable operating system such as IBM's zSeries/Operating System (z/OS), MS-DOS, PC-DOS, MAC-iOS, WINDOWS, UNIX, OpenVMS, ANDROID, an operating system based on LINUX, or any other appropriate operating system, including future operating systems.

In particular embodiments, the computing system includes a processor, memory, a user interface, and a communication interface. In particular embodiments, the processor includes hardware for executing instructions, such as those making up a computer program. The memory includes main memory for storing instructions such as computer program(s) for the processor to execute, or data for processor to operate on. The memory may include an HDD, a Secure Digital (SD), a floppy disk drive, flash memory, an optical disc, a magneto-optical disc, magnetic tape, a Universal Serial Bus (USB) drive, a solid-state drive (SSD), or a combination of two or more of these. The memory may include removable or non-removable (or fixed) media, where appropriate. The memory may be internal or external to computing system, where appropriate. In particular embodiments, the memory is non-volatile, solid-state memory.

The user interface includes hardware, software, or both providing one or more interfaces for user communication with the computing system. As an example and not by way of limitation, the user interface may include a keyboard, keypad, microphone, monitor, mouse, printer, scanner, speaker, still camera, stylus, tablet, touchscreen, trackball, video camera, another user interface or a combination of two or more of these.

The communication interface 39 of the computing system and the adapter 10 include hardware, software, or both providing one or more interfaces for communication (e.g., packet-based communication) between the adapter 10 and one or more other computing systems or one or more networks 45. As an example and not by way of limitation, communication interface may include a network interface controller (NIC) or network adapter for communicating with an Ethernet or other wire-based network or a wireless NIC (WNIC) or wireless adapter for communicating with a wireless network 45, such as a WI-FI network. This disclosure contemplates any suitable network and any suitable communication interface. As an example and not by way of limitation, the adapter 10 and computing system may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the computing system may communicate with a wireless PAN (WPAN) (e.g., a BLUETOOTH WPAN), a WI-FI network, a WI-MAX network, a cellular telephone network (e.g., a Global System for Mobile Communications (GSM) network), or other suitable wireless network or a combination of two or more of these. The adapter 10 and computing system may include any suitable communication interface for any of these networks, where appropriate.

In certain embodiments, the primary adapter 10a of the present invention includes a housing 20. The housing 20 may include a circuit board. The processor 39 the communications interface 41, the sensors 18, and the camera 28 may be disposed within the housing 20 and may be electrically connected to the circuit board. The primary adapter 10a may further include an electrical joint housing 36a electrically connecting the housing 20, the bulb connector 22a, and the bulb socket 35a.

In certain embodiments, the bulb connector 22a is coupled to the electrical joint housing 36a by a first ball joint 24a. For example, the first ball joint 24a is disposed within a first socket 38a of the bulb connector 22a and a second socket 37a of the electrical joint housing 36a. The first ball joint 24a allows the electrical joint housing 36a to be moveable along an x axis and y axis relative to the bulb connector 22a. In certain embodiments, the housing 20 is coupled to the electrical joint housing 36a by a second ball joint 26, allowing the housing 20 to rotate along an axis relative to the electrical joint housing 36a. The first and second ball joint connections allow a user to position the sensors 18 and camera 28 to point to a desired location relative to the bulb fixture 12.

The primary adapter 10a of the present invention may further include a speaker and a microphone 30. The speaker and microphone 30 are coupled to the housing 20, electrically coupled to the circuit board, and thereby electrically connected to the bulb connector 22a. In such embodiments, the microphone 30 is also switched on when the sensors 28 senses a motion.

In certain embodiments, the remote device 43 receives video signals from the primary adapter 10a and also sends commands to the primary adapter 10a. In such embodiments, a software may be loaded on the memory of the remote device 43. For example, an application may be loaded on a smart phone. Once the application is loaded on a smart phone, the primary adapter(s) 10a are registered. The primary adapter 10a is then connected to a wireless network 45 and the remote device 43 may now wirelessly communicate with the primary adapter 10a over the network 45. The remote device 43 may wirelessly communicate with the processor 41 of the primary adapter 10a via the wireless communications interface 39 to turn the sensors on and off. Further, the remote device 43 may be used to adjust the proximity range 42 of the sensors 18.

When the sensors 18 are turned on and thereby activated, the camera 28, the speaker and microphone 30, and the bulb socket 35a are switched on when the sensors 18 sense a motion by a potential intruder 40 within a proximity range 42 of the sensors 18. If a light bulb 16a is attached to the bulb socket 35, the light bulb 16a turns on. An alert is sent to the remote device 43, indicating that the motion sensors 18 has sensed the motion. The video and sound signals are also sent to the remote device 43, such as a live feed of the camera 28 and a live feed of the speaker and microphone 30. In certain embodiments, the remote device 43 wirelessly communicates with the processor 41 via the wireless communications interface 39 to control an output of the speaker 30 for a two-way remote communication. A user initiates a button on the remote device 43 and begins to speak. An audio signal is sent to the primary adapter 10a via the communications interface 39 and a live feed of the user's audio is produced by the speaker 30. For example, the user may remotely instruct the intruder 40 to leave the property. Additionally, the user may initiate a siren to play on the speaker 30 of the adapter 10 to scare the intruder 40 away. Moreover, the adapter 10 enables the user to access the lighting fixture's 12 functions remotely—turning the light function on and off, setting a timer, using as an every-day light, and two-way communication all through the wireless communications interface 39.

In certain embodiments, the present invention may include a secondary adapter 10b. The secondary adapter 10b includes a bulb connector 22b having male threads. The secondary adapter 10b further includes a bulb socket 35b having female threads. The bulb socket 35b is electrically connected to the bulb connector 22b. An electrical joint housing 36b electrically connects, the bulb connector 22b and the bulb socket 35b. The secondary adapter 10b further includes a wireless communications interface 50 disposed within the electrical joint housing 36b that is electrically connected to the bulb connector 22b. When the bulb connector 22b is connected to a bulb fixture 12 of a wall 14, the wireless communications interface 50 and the bulb socket 35b are powered.

Similar to the primary adapter 10a, a first ball joint 24b is disposed within a first socket 38b of the bulb connector 22b and a second socket 37b of the electrical joint housing 36b. The first ball joint 24b allows the electrical joint housing 36b to be moveable along an x axis and y axis relative to the bulb connector 22b.

The wireless communications interface 50 may include an RFID chip. The wireless communications interface 50 syncs with the wireless communications interface 39 of the primary adapter 10a. In such embodiments, when the sensors 18 of the primary adapter 10 sense a motion, the light bulb 16b coupled to the bulb socket 35b of the secondary adapter 10b turns on simultaneously with the light bulb 16a coupled to the bulb socket 35a of the primary adapter 10a.

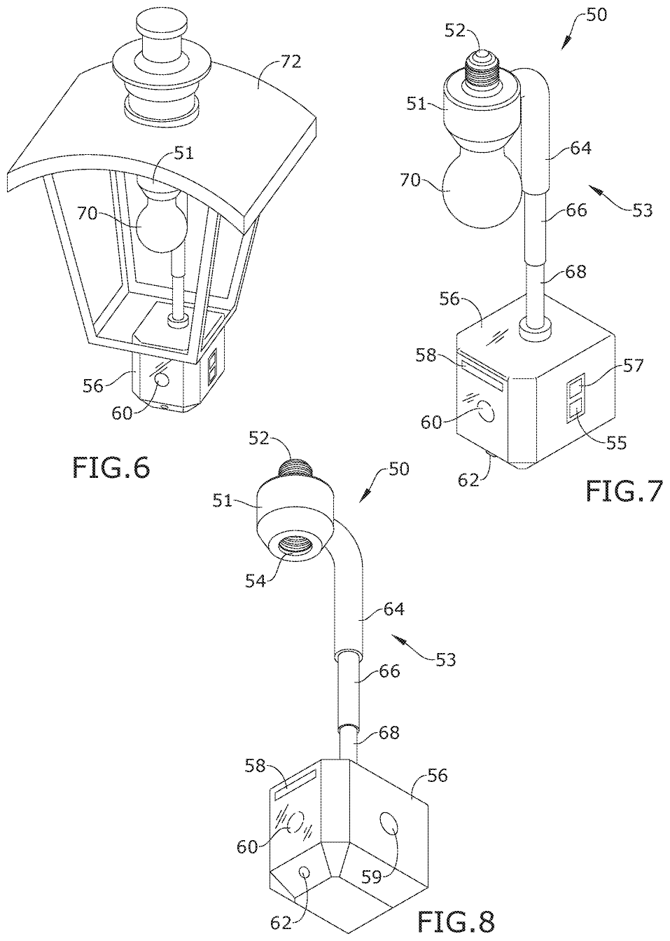

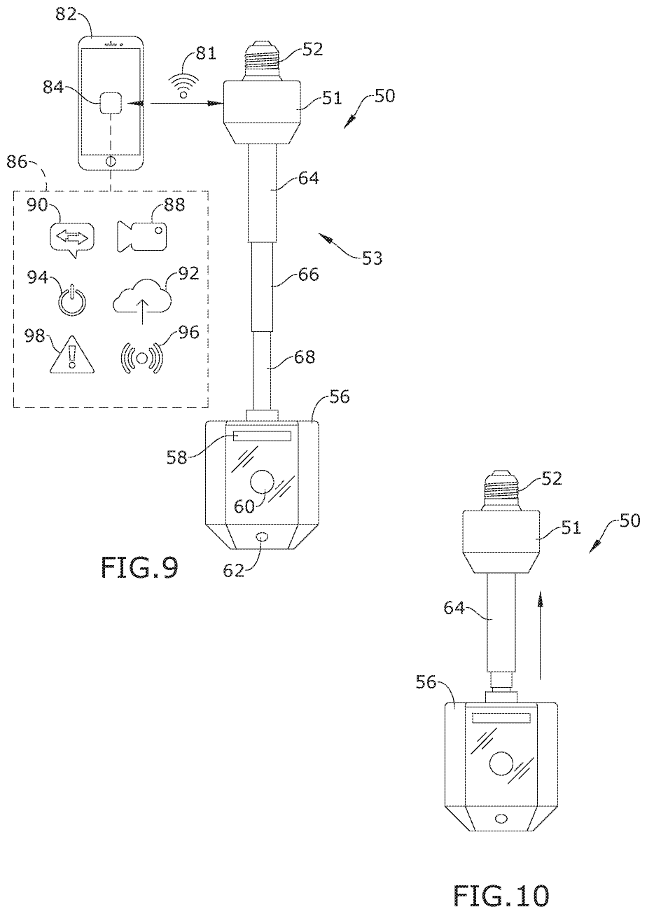

Referring to FIGS. 6 through 10, the present invention includes a home security light bulb adapter 50. The home security light bulb adapter 50 includes a light bulb base 51. The light bulb base 51 includes a male bulb connector 52 having male threads and a female bulb socket 54 having female threads. The male bulb connector 52 is electrically connected to the female bulb socket 54. The present invention further includes an elongated rod 53 and a housing 56. A camera 60 with night vision 58 and a motion sensor 62 are coupled to the housing 56. The housing 56 is coupled to the light bulb base 51 by the elongated rod 53. The present invention further includes a processor 57 and a wireless communications interface 55. The camera 60, the motion sensor 62, the processor 57, and the wireless communications interface 55 are electrically connected to the male bulb connector 52. When the male bulb connector 52 is connected to a bulb fixture of a lantern light fixture 72, the camera 60 is switched on when the motion sensor 62 senses a motion. The processor 57 then sends video signals to a remote device 82 over a network 81 via the wireless communications interface 57.

The remote device 82 of the present invention may be a laptop, desktop, or a smart device, such as a smart phone or a tablet with a computing system. The computing system is at least a processor and a memory. The computing system may execute on any suitable operating system such as IBM's zSeries/Operating System (z/OS), MS-DOS, PC-DOS, MAC-iOS, WINDOWS, UNIX, OpenVMS, ANDROID, an operating system based on LINUX, or any other appropriate operating system, including future operating systems.

In particular embodiments, the computing system includes a processor, memory, a user interface, and a communication interface. In particular embodiments, the processor includes hardware for executing instructions, such as those making up a computer program. The memory includes main memory for storing instructions such as computer program(s) for the processor to execute, or data for processor to operate on. The memory may include an HDD, a Secure Digital (SD), a floppy disk drive, flash memory, an optical disc, a magneto-optical disc, magnetic tape, a Universal Serial Bus (USB) drive, a solid-state drive (SSD), or a combination of two or more of these. The memory may include removable or non-removable (or fixed) media, where appropriate. The memory may be internal or external to computing system, where appropriate. In particular embodiments, the memory is non-volatile, solid-state memory.

The user interface includes hardware, software, or both providing one or more interfaces for user communication with the computing system. As an example and not by way of limitation, the user interface may include a keyboard, keypad, microphone, monitor, mouse, printer, scanner, speaker, still camera, stylus, tablet, touchscreen, trackball, video camera, another user interface or a combination of two or more of these.

The communication interfaces of the computing system and the adapter 50 include hardware, software, or both providing one or more interfaces for communication (e.g., packet-based communication) between the adapter 50 and one or more other computing systems or one or more networks 81. As an example and not by way of limitation, communication interface may include a network interface controller (NIC) or network adapter for communicating with an Ethernet or other wire-based network or a wireless NIC (WNIC) or wireless adapter for communicating with a wireless network 81, such as a WI-FI network. This disclosure contemplates any suitable network and any suitable communication interface. As an example and not by way of limitation, the adapter 50 and computing system may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the computing system may communicate with a wireless PAN (WPAN) (e.g., a BLUETOOTH WPAN), a WI-FI network, a WI-MAX network, a cellular telephone network (e.g., a Global System for Mobile Communications (GSM) network), or other suitable wireless network or a combination of two or more of these. The adapter 50 and computing system may include any suitable communication interface for any of these networks, where appropriate.

The housing 56 may include a circuit board disposed therein. The processor 57, the communications interface 55, the motion sensor 62, and the camera 60 may be electrically connected to the circuit board. The circuit board may be electrical connected the male bulb connector 52.

The adapter 50 of the present invention may further include a speaker and a microphone 59. The speaker and microphone 59 are coupled to the housing 56, electrically coupled to the circuit board, and thereby electrically connected to the male bulb connector 52. In such embodiments, the microphone 59 is also switched on when the motion sensor 62 senses a motion.

The elongated rod 53 may include an upper section 64, a middle section 66, and a lower section 68. The upper section 64 is coupled to the light bulb base 51, extends laterally therefrom and has a 90 degree turn to extend downward from the light bulb base 51. This allows the light bulb base 51 to electrical coupled to an electrical socket within a lantern light fixture 72 with the housing 56 disposed beneath the lantern light fixture 72. The middle section 66 and the lower section 68 are telescoping members that allow the elongated rod 53 to extend and retract and thereby adjust in length. This allows the present invention to be used with different sized lantern light fixtures 72.

In certain embodiments, the remote device 82 receives video signals from the adapter 50 and also sends commands to the adapter 50. In such embodiments, a software 84 may be loaded on the memory of the remote device 82. For example, an application may be loaded on a smart phone. Once the application is loaded on a smart phone, the adapter 50 may be registered. The adapter 50 is then connected to a wireless network 81 and the remote device 82 may wirelessly communicate with the adapter 50 over the network 81. The remote device 82 may wirelessly communicate with the processor 57 of the adapter 50 via the wireless communications interface 55 to turn on and off multiple features 86 of the adapter 50. For example, the remote device 82 may produce or include a button 98 to turn the motion sensor 62 on and off, a button 88 to turn a video stream on and off, a button 90 to turn on a two way communication on and off, a button 92 to turn a cloud storage function on and off, a button 94 to turn the entire unit on and off, and a button 96 to turn an alarm function on and off. The buttons mentioned above may be a mechanical button or a digital button, such as a touch screen button. Additionally, the remote device 82 may be used to adjust the proximity range of the motion sensor 62. In certain embodiments, a plurality of adapters 50 may be paired and registered together such that the remote device 82 may control all of the adapters 50 at the same time.

When the motion sensor 62 is turned on and thereby activated, the camera 60 and the speaker and microphone 59 may be switched on when the motion sensor 62 senses a motion by a potential intruder within a proximity range of the motion sensor 62. An alert is sent to the remote device 82, indicating that the motion sensor 62 has sensed the motion. The video and sound signals are also sent to the remote device 82, such as a live feed of the camera 60 and a live feed of the speaker and microphone 59. In certain embodiments, the remote device 82 wirelessly communicates with the processor 57 via the wireless communications interface 55 to control an output of the speaker 59 for the two-way remote communication. A user initiates the button 90 on the remote device 82 and begins to speak. An audio signal is sent to the adapter 50 via the wireless communications interface 55 and a live feed of the user's audio is projected by the speaker 59. For example, the user may remotely instruct the intruder to leave the property. Additionally, the user may press the button 96 to initiate a siren to play on the speaker 59 of the adapter 50 to scare the intruder away. If the motion sensor 62 is turned off by the button 94, the present invention may be used as a standard lantern light fixture.

The present invention acts an as adaptor to still use the light bulb but add in the unique features of smart home security within minutes. This includes a night vision camera, motion sensor technology, 2-way audio communication with a built-in microphone, and remote monitoring from an application loaded on a smart device. The above mentioned features are provided without having to hardwire a new fixture or incur additional expenses to hire a professional to install.

It should be understood, of course, that the foregoing relates to exemplary embodiments of the invention and that modifications may be made without departing from the spirit and scope of the invention as set forth in the following claims.

What is claimed is:

1. A home security light bulb adapter comprising:
a light bulb base comprising a male bulb connector having male threads and a female bulb socket having female threads, wherein the female bulb socket is electrically connected to the male bulb connector;
an elongated rod;
a housing connected to the light bulb base by the elongated rod;
a camera coupled to the housing and electrically connected to the male bulb connector;
a motion sensor coupled to the housing and electrically connected to the male bulb connector;
a wireless communications interface electrically connected to the male bulb connector; and
a processor electrically connected to the male bulb connector; wherein
when the male bulb connector is connected to a bulb fixture and the motion sensor senses a motion, the camera is activated and the processor sends video signals captured by the camera to a remote device via the wireless communications interface.

2. The home security light bulb adapter of claim 1, wherein the remote device wirelessly communicates with the processor via the wireless communications interface to turn the motion sensor on and off.

3. The home security light bulb adapter of claim 1, wherein the video signals are a live feed of the camera.

4. The home security light bulb adapter of claim 1, further comprising a speaker and a microphone coupled to the housing and each electrically connected to the male bulb connector, wherein the microphone is switched on when the motion sensor sensed a motion, wherein the processor sends audio signals to the remote device via the wireless communications interface.

5. The home security light bulb adapter of claim 4, wherein the remote device wirelessly communicates with the processor via the wireless communications interface to control an output of the speaker.

6. The home security light bulb adapter of claim 1, wherein the elongated rod is telescoping to adjust in length.

7. The home security light bulb adapter of claim 6, wherein the elongated rod comprises an upper section, a middle section, and a lower section telescoping relative to one another, wherein the upper section is coupled to the light bulb base and the lower section is coupled to the housing.

8. The home security light bulb adapter of claim 7, wherein the upper section extends laterally from the light bulb base and comprises a 90 degree turn to extend downward from the light bulb base.
